(19) United States
(12) Patent Application Publication
(10) Pub. No.: US 2006/0059739 A1
(43) Pub. Date: Mar. 23, 2006

(54) Advertisement print optimized for a viewer having two viewpoints

(76) Inventor: Christian Sondergaard, Flyvestation Vandel (DK)

Correspondence Address: PITNEY HARDIN LLP, 7 TIMES SQUARE, NEW YORK, NY, 10036-7311, US

(21) Appl. No.: 10/526,086

(22) PCT Filed: Aug. 22, 2003
(86) PCT No.: PCT/DK03/00553

§ 371 Date: Jul. 28, 2005

Related U.S. Application Data
(63) Continuation-in-part of application No. 10/225,169, filed on Aug. 22, 2002, now abandoned.

(51) Int. Cl. G09F 19/14

(52) U.S. Cl. 40/453

(57) ABSTRACT

The invention relates to an advertisement print being printed on a print carrier. The print illustrates a transformation of a three-dimensional element, where the print is optimized for a viewer having two viewpoints, a first viewpoint and a second viewpoint being placed on each side of a central fictive viewpoint. The print comprises a right side being a perspective projection of said three-dimensional element to said print carrier, where the projection is optimized to the firt viewpoint. Further, the print comprises a left side being a perspective projection of the three-dimensional element to the print carrier, where the projection is optimized to the second viewpoint.

### FIELD OF THE INVENTION

The invention relates to an advertisement print being printed on a print carrier. The invention also relates to a method of generating an advertisement print on a print carrier comprising a first substantially plane print carrier. Furthermore, the invention relates to a computer readable medium having stored therein instructions for causing a processing unit to execute the method of generating an advertisement print on a print carrier.

### BACKGROUND OF THE INVENTION

The use of advertising has increased heavily during the past years and is used in different forms such as TV commercials, Internet advertisement, advertisements in newspapers and magazines and static printed advertisements being placed in the environment both outdoor and indoor with the purpose of advertising for the people passing by the advertisement.

With regard to static printed advertisement, a problem is often that people do not notice the advertisement, mainly because they are getting used to advertisements, which makes it more and more difficult to attract people's attention. Another problem with the printed advertisements is that they are limited for presenting information in two dimensions, limiting the types of information that can be expressed by a static printed advertisement. This is especially the case when the viewer is not positioned at 90° (or close to that) in front of the advertisement.

WO 93/04559 describes an image, e.g. having an advertising or promotional nature, which is depicted by inverse perspective transformation on a playing field for a sporting event. The playing field is imaged by means of a video camera whose line of sight corresponds to the line of sight used in transforming the image to its inverse perspective form, and the output of the camera is then broadcasted or diffused in a television broadcasting or diffusion service. Thereby, because of perspective transformation, the viewer viewing the broadcasted image intercepts a perspective transformation of the image. A problem with this is that in order for the viewer to see the correct perspective transformation of the image, it is necessary to use the video camera whose line of sight corresponds to the line of sight used in transforming the image to its inverse perspective form. Further, if a person looks directly at the inverse perspective transformation, the viewer will not be able to intercept the perspective transformation because the inverse transformation has been performed according to a single viewpoint, where a viewer has two eyes and thereby two viewpoints. Especially when the viewer is close to the inverse perspective transformation this is a problem and the invention is therefore mainly useable in sports arenas where the viewpoint is a camera, which is placed with a long distance to the inverse perspective transformation.

### OBJECT AND SUMMARY OF THE INVENTION

It is an object of the invention to provide an advertisement print solving the above-mentioned problem.

This is obtained by an advertisement print being printed on a print carrier, said print illustrates a transformation of a three-dimensional element, where said print is optimised for a viewer having two viewpoints, a first viewpoint and a second viewpoint being placed on each side of a central fictive viewpoint. The print comprises:
a right side being a perspective projection of said three-dimensional element to said print carrier, said projection being optimised to said first viewpoint and
a left side being a perspective projection of said three-dimensional element to said print carrier, said projection being optimised to said second viewpoint.

Thereby a print is obtained providing the illusion of a three-dimensional element for a viewer having two viewpoints a left and a right eye. It is not necessary that the advertisement print is being viewed via a camera, now the viewer can look directly at the advertisement print at a close range (typically 2→20 m) and get the illusion that he/she looks at a three-dimensional element. The invention can thereby advantageously be used for advertisement in places such as supermarkets, exhibitions etc.

In a specific embodiment, the first viewpoint is placed on the right side of said central fictive viewpoint and said second viewpoint is placed on the left side of said central fictive viewpoint. By using the left eye for projecting the right side of the three-dimensional element and by using the right eye for projecting the left side of the three-dimensional element, tests have shown that an advertisement print is obtained which gives a very good illusion.

In an embodiment, the print carrier is a removable mat. Thereby the image can easily be removed and e.g. replaced by another mat. Further, the image can be produced at a first production place and then placed at a surface afterwards. The surface could be a plane surface, such as a ceiling, a floor or a wall.

In another embodiment, a projector pointing towards the print carrier provides said print. Thereby the image can easily be applied and changed. The image could e.g. be changed continuously whereby the image or part of it can present a three-dimensional animation e.g. a flashing price tag, a “buy now” or a spinning bottle.

The invention further relates to a method of generating an advertisement print on a print carrier, said print being a transformation of a three-dimensional element, where said transformation is optimised for a viewer having two viewpoints, a first viewpoint and a second viewpoint being placed on the each side of said central fictive viewpoint, the method comprises the steps of:
performing a perspective projection of the three-dimensional element to said print carrier according to said central fictive viewpoint,
adjusting a right part of said perspective projection according to said first viewpoint,
adjusting a left part of said perspective projection according to said second viewpoint.

This is an easy way of generating the advertisement print. Known techniques can be used for performing the projection of the three-dimensional element, where after the projection can easily be adjusted according to the first and second viewpoint.

In a specific embodiment, the step of performing the projection of the three-dimensional element to the print carrier is performed by the steps of:
generating a plane of projection being a two-dimensional image of the three-dimensional element, said plane of projection being generated in a position perpendicular to a line of sight defined between the fictive viewpoint and the centre of said plane of projection,
perspective projecting the plane of projection to the print carrier according to said central fictive viewpoint.

By first generating a plane of projection and then projecting the plane, the method of generating the advertisement print is simplified. The plane of projection can easily be generated by taking a photo of the three-dimensional element in the line of sight and then projecting the photo to the print carrier. Alternatively, this could all be preformed using a computer program for handling the projections. This would require that a model of the three-dimensional element is presented to the computer program e.g. by drawing a three-dimensional model, as well as it would require that the viewer-data are sufficient to provide projection data (e.g. height, distance to object, distance between viewpoints and so on).

In a specific embodiment, projecting the plane of projection to the print carrier is performed by dividing the plane of projection into a number of horizontal sub masks and then projecting each sub mask to said print carrier according to a line of sight defined between said central viewpoint and a point in said sub mask onto a given surface. Thereby an advantageous advertisement print is obtained resulting in an advertisement print giving an improved illusion, because proportional projection is performed when generating the length of the advertisement print. This is significantly important at view angles between 0° and 45° since the proportional stretching factor is higher than the lower view angle.

In another specific embodiment, the step of adjusting the right part of said perspective projection, according to said first line of sight, is performed by stretching the right side of the perspective projection towards said first line of sight, and the step of adjusting the left part of said perspective projection according to said second line of sight is performed by stretching the left side of the perspective projection towards said second line of sight. This is an especially easy way of generating an advertisement print being optimised for a viewer having two viewpoints (to eyes). Instead of projecting the plane of projection for each eye, a central viewpoint can be used for generating a temporary advertisement print after which the temporary advertisement print is stretched according to each eye resulting in an advertisement print giving an improved illusion.

In an embodiment, the stretching of the right side of the perspective projection towards said first line of sight is performed in such a way that the edges of the right side become parallel with said first line of sight and wherein the stretching of the left side of the perspective projection towards said second line of sight is performed in such a way that the edges of the left is side become parallel with said second line of sight. Tests have shown that by stretching in the way described in the above, a very good illusion can be obtained from the generated advertisement print.

In an embodiment, the stretching is performed by dividing the perspective projection into a number of vertical sub masks, stretching each sub mask in the right side of the projection according to a line of sight defined between said sub mask and a first viewpoint and stretching each sub mask in the left side of the projection according to a line of sight defined between said sub mask and a second viewpoint. Thereby an advantageous advertisement print is obtained resulting in an advertisement print giving an improved illusion, because proportional projection is performed when generating the width of the advertisement print.

In a specific embodiment, the first viewpoint is placed on the right side of said central fictive viewpoint and said second viewpoint is placed on the left side of said central fictive viewpoint. By using the left eye for projecting the right side of the three-dimensional element and by using the right eye for projecting the left side of the three-dimensional element, tests have shown that an advertisement print is obtained which gives a very good illusion.

In a specific embodiment the transformation is further optimised for the viewer by graphically adjusting the contents of the advertisement print. By graphically adjusting the contents such as adjusting contrast of the colours, adding or enhancing shadows and enhancing edges in the contents of the print the illusion to be provided by the print can be optimised.

In a specific embodiment the graphical adjustment is made based on a simulation of the advertisement print on the print carrier. The simulation could be made by either using a projector pointing substantially perpendicular towards the print carrier, alternatively it could be made by placing a plasma display on the print carrier. Via a computer containing an electronic version of the advertisement print, the graphical adjustment of the contents of the advertisement print can easily be performed to optimize the illusion of the advertisement print.

The invention further relates to a computer readable medium having stored therein instructions for causing a processing unit to execute the method described above.

### BRIEF DESCRIPTION OF THE DRAWINGS

In the following, preferred embodiments of the invention will be described referring to the figures, wherein

FIG. 1a and 1b illustrate a side view and a top view of how a print according to the present invention can be made,

FIG. 2a and 2b illustrate a side view and a top view of a specific embodiment of how a print according to the present invention can be made,

FIG. 3 illustrates how the length of a substantially plane print is determined,

FIG. 4a and 4b illustrate proportional stretching of the plane of projection in length,

FIG. 5 illustrates how the size of each projected sub mask is determined,

FIG. 6a and 6b illustrate proportional stretching of the plane of projection in width.

FIG. 7 illustrates an embodiment of a print according to the present invention where linear stretching has been used when generating the print,

FIG. 8 illustrates another embodiment of the print in FIG. 6 where proportional stretching has been used when generating the print,

FIG. 9 illustrates how the print of FIG. 6 and 7 is intercepted by a viewer having two viewpoints,

FIG. 10 illustrates another embodiment of a print according to the present invention,

FIG. 11 illustrates how the print of FIG. 10 is intercepted by a viewer having two viewpoints,

FIG. 12 illustrates how the size of each projected sub mask is determined, when projecting the mask to a surface comprising two substantially plane surfaces.

### DESCRIPTION OF PREFERRED EMBODIMENTS

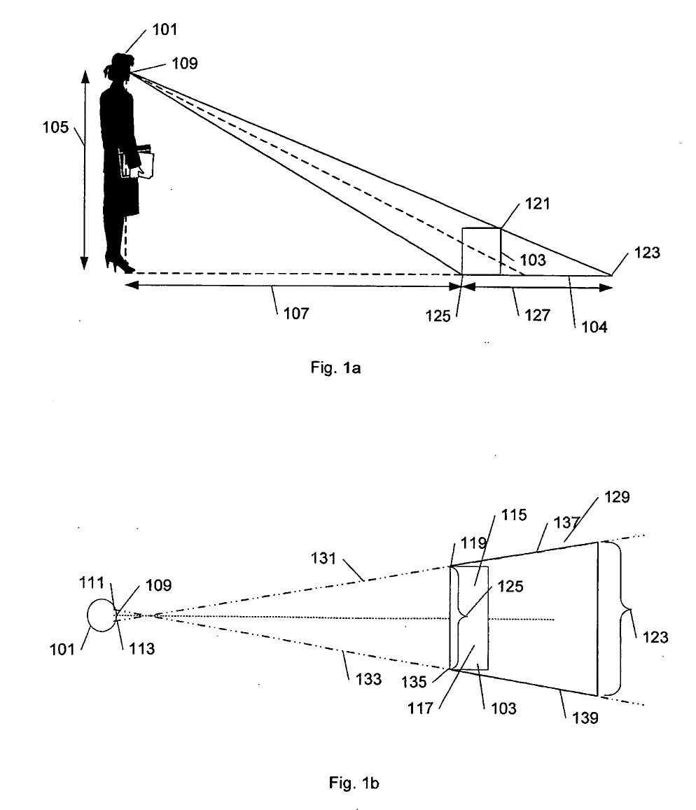

FIGS. 1a and 1b illustrate how a print according to the present invention can be made. The figures illustrate the viewer 101 together with a cube shaped three-dimensional object 103, which is to be transformed to the print carrier 104. In FIG. 1a, a side view of the viewer 101 and the object 103 is illustrated and in FIG. 1b, a top view of the viewer 101 and the object 103 is illustrated.

In order to perform the projection, it is first determined which viewpoint (also called central fictive viewpoint 109) the print is to be optimised for. In FIG. 1, the position is determined by using the distance 105 from the ground to the central fictive viewpoint 109 and the distance 107 between the central fictive viewpoint 109 and the front of the three-dimensional object 103.

Each point in the three-dimensional object 103 is then projected to a point on the print carrier 104. This is performed according to a projection line defined as a line connecting the point in the three-dimensional element to be projected and the central fictive viewpoint 109. In 1a, it is to be noticed that the points being placed at the longest distance from the viewer are the points 123 being a projection of the points 121 in the cube, and the points being placed at the shortest distance from the viewer are the points 125. Thereby the total length of the print 127 is the distance between the points 123 and 125. The applied projection is then a perspective projection, meaning that each point has its own projection vector or projection line defined by the central fictive viewpoint and the selected point on the 3D object.

Since the viewer 101 has two viewpoints, a left 111 and a right 113, it is necessary to compensate by choosing the left viewpoint 111 for projecting one side 117 of the element and then choosing the right viewpoint 113 for the other side 115 of the element. The left and the right viewpoint are defined as being on the left and the right side of the central fictive viewpoint 109 and approximately in the same vertical axis as the central fictive viewpoint 109. In FIG. 1b, the left viewpoint 11 has been used for the right side 117 and the right viewpoint 113 has been used for the left side 115. In another embodiment, this could be different such that the left viewpoint is used for the left side and the right viewpoint is used for the right side. In FIG. 1b, the left boundary 137 of the print 129 is parallel to the projection line 131 connecting the right viewpoint 113 and the point 119, and the right boundary 139 of the print 129 is parallel to the projection line 133 connecting the left viewpoint 111 and the point 135.

After having, in the above, described some properties of a print generated by a projection of a three-dimensional element, a method of generating a print will be described in the following.

It can be a complex affair to perform the projection of a physical three-dimensional element. One way of doing it could be by generating a model of the physical element in a computer program and then performing the projection using the computer program according to the above described. This would require that it is possible to generate a computer model of the element, and especially in the case of very complex elements this could be a very cumbersome process.

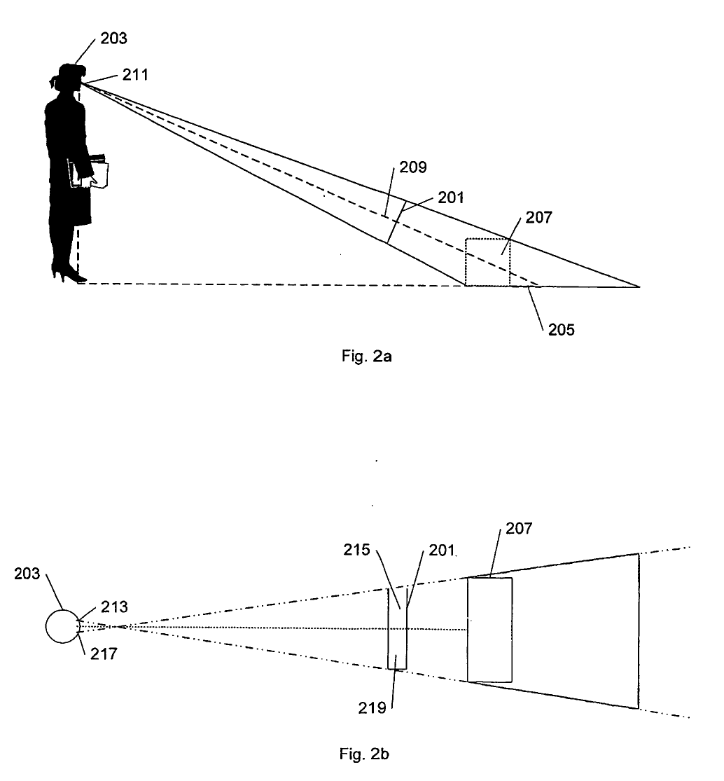

Alternatively, it could be performed in a more simple and cost effective way illustrated by FIG. 2a and 2b. Here a plane of projection 201 has been generated between the viewer 203 and the print carrier 205, where the plane of projection 201 is a two-dimensional plane to which the three-dimensional element 207 has been projected. In a specific embodiment, the plane of projection can easily be generated by taking a photo of the three-dimensional element 207 from a predefined point in the line of sight 209 defined between the viewpoint 211 and the three-dimensional element 207, or it can be generated by using a combination of 2 photos taken from each of the viewpoints 213 and 217 and projected onto the plane 201.

The plane of projection 201 is then projected to the print carrier 205, similar to the method of projecting the three-dimensional element, by projecting each point in the plane of projection 201 to a point on the print carrier 205 according to a projection line connecting the viewpoint 211 and the point on the plane. Again, since the viewer has two viewpoints, a left and a right eye, it is necessary to compensate by choosing the left viewpoint for projecting one side of the plane and then choosing the right viewpoint for the other side of the plane. In FIG. 2b, the left viewpoint 213 has been used for the right side 219 and the right viewpoint 217 has been used for the left side 215.

In the following, it is described how the projection can be performed by stretching the plane of projection in both width and length according to determined boundaries.

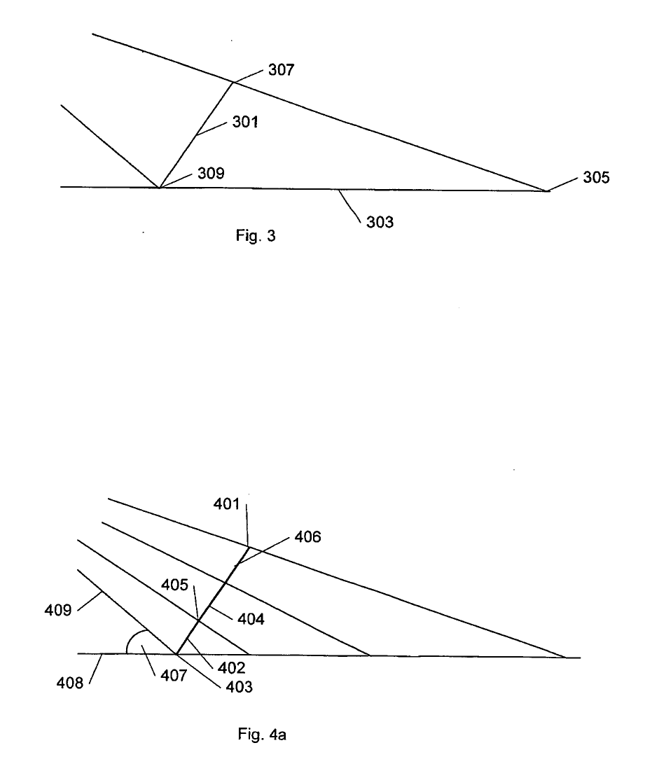

In FIG. 3, it is illustrated how much the plane of projection is to be stretched in length. The plane of projection is illustrated by 301, when the plane of projection is projected to the print carrier 303, the points on the print being placed at the longest distance from the viewer are the points 305 being a projection of the points 307 in the plane of projection 301. The points being placed at the shortest distance from the viewer are the points 309. Thereby the total length of the print is the distance between the points 305 and 309. Having determined the length boundaries 305 and 309, the print can be generated by stretching the plane of projection in such a way that the point 307 is placed at the point 305. The stretching could be performed in a simple linear way; however, this would distort the element, which is to be illustrated by the print making the illusion to be obtained by the print less effective.

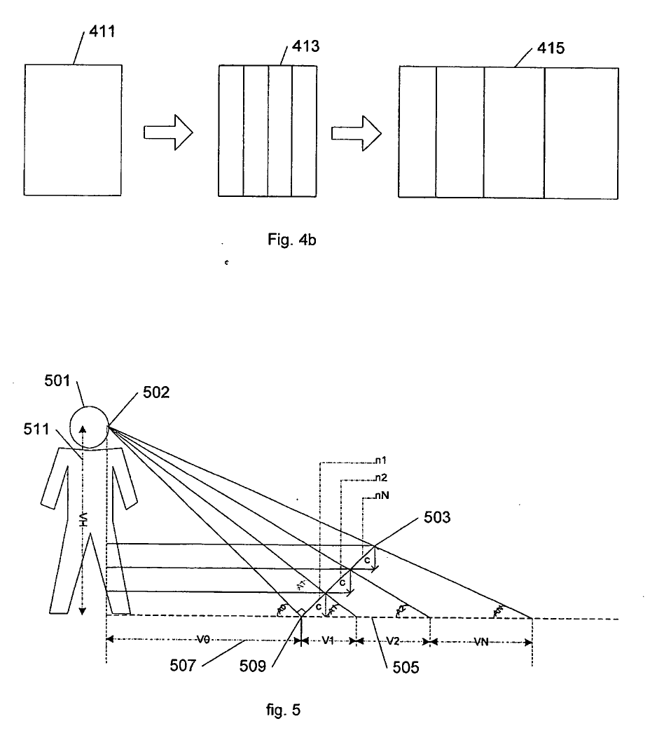

In FIG. 4a and 4b proportional stretching is introduced, which, compared to the linear stretching described above, results in less distortion in the element, which is to be illustrated by the print. The plane of projection 401 is divided into equally sized sub masks 402, 404 and 406 and for each sub mask a top point 405 and a bottom point 403 is defined. The top point 405 and the bottom point 403 are then projected to the print in order to define the length of the sub mask; thereafter each sub mask is stretched similar to the method described in connection with FIG. 3.

In FIG. 4b, the plane of projection is shown from an angle perpendicular to the plane of projection, and it is illustrated how the print can be generated by stretching the plane of projection. The plane of projection is first illustrated in 411, then a number of sub masks are defined as shown in 413. Each sub mask is calculated and finally the projected print 415 is obtained by stretching each sub mask depending on the angle between the line of sight and the print carrier. The sub masks having the longest distance to the viewpoint are stretched the most, since the angle between the surface and the line from the viewpoint to the top sub mask is the smallest. In theory, the optimal projection would be to divide the plane of projection into an infinite number of sub masks, however, testing has shown that dividing the plane of projection into sub masks having a height being approximately 5-10% of the total height of the plane of projection results in quite a good improvement of the projection compared to linear stretching or orthogonal projection in a 3D-Computer Aided Design program.

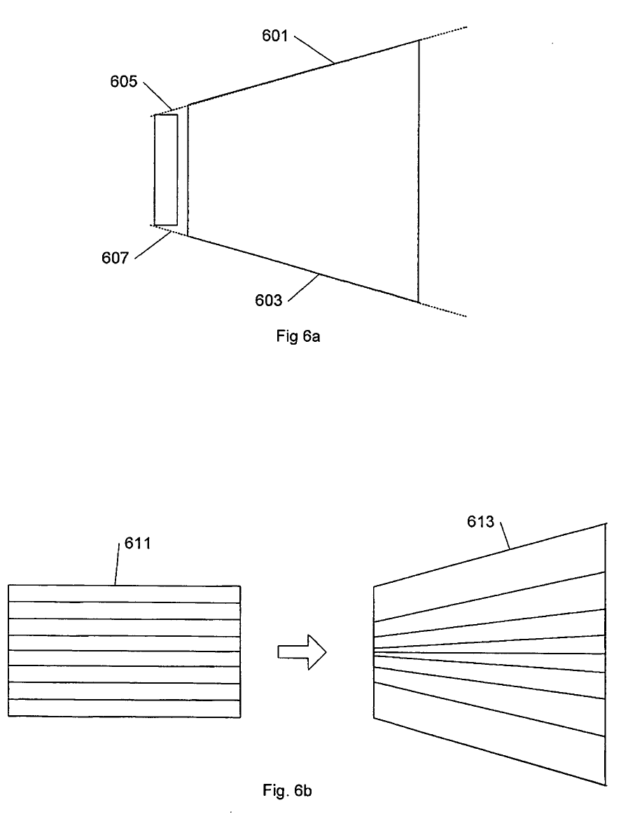

Using FIG. 5, it is explained how the size of each projected sub mask is determined and thereby how much each sub mask should be stretched. The figure illustrates the viewer 501 with the central fictive viewpoint 502 and the plane of projection 503. The plane of projection has been horizontally divided into a number of sub masks n1→nN, where n1 is the first sub mask and nN is the final sub mask in the plane of projection 503. First the angles A1→AN must be determined, which can be done according to the following formula:

$$∠ An = A tan ( \frac{VH - nn \times c \times sin ( 90 - A0 )}{V0 + nn \times c \times cos ( 90 - A0 )} )$$

where nn is the sub mask number and An is the angle between the projection line and the projection surface 505, the projection line being defined between the central fictive viewpoint 502 and the top point of the sub mask nn. V0 is the ground distance 507 between the central fictive viewpoint 502 and the bottom projection point 509 of the plane of projection 503. A0 is the angle between the projection line and the projection surface 505, the projection line being defined between the central fictive viewpoint 502 and the bottom point of the sub mask n1. VH is the upright distance 511 from the projection surface 505 to the central fictive viewpoint 502. After having determined the angles A1→AN the length of each projected sub mask V1→VN can be determined by the following:

$$Vn = \frac{VH}{( \frac{VH - nn \times c \times sin ( 90 - A0 )}{V0 + nn \times c \times cos ( 90 - A0 )} )} - \frac{VH}{( \frac{VH - ( nn - 1 ) \times c \times sin ( 90 - A0 )}{V0 + ( nn - 1 ) \times c \times cos ( 90 - A0 )} )}$$

where Vn is the length of the n'th projected sub mask. Having determined V1→VN each sub mask n1→nN can be stretched accordingly.

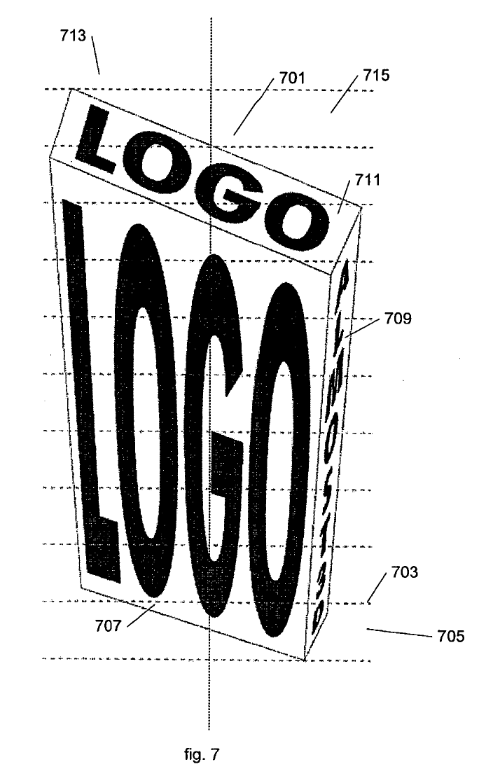

In FIG. 6a and 6b, the left width boundary 601 and the right width boundary 603 of the print are illustrated. The left width boundary 601 is defined as being parallel to the projection line 605 from the first viewpoint to the left corner point of the object in the plane of projection; and the right width boundary 603 is defined as being parallel to the projection line 607 from the second viewpoint, being different from the first viewpoint, to the right corner point of the object in the plane of projection, where the first and second viewpoint are either the left or right eye. Having defined the left and the right boundaries and the print having been stretched in length, the print can now be stretched in width according to the defined boundaries. In FIG. 6b, the print having been stretched in length is illustrated in 611 being divided in a number of vertical sub masks, and in 613 it is illustrated how each sub mask is stretched proportionally. Again, the stretching could be performed linear, but by using proportional stretching it results in less distortion in the element, which is to be illustrated by the print.

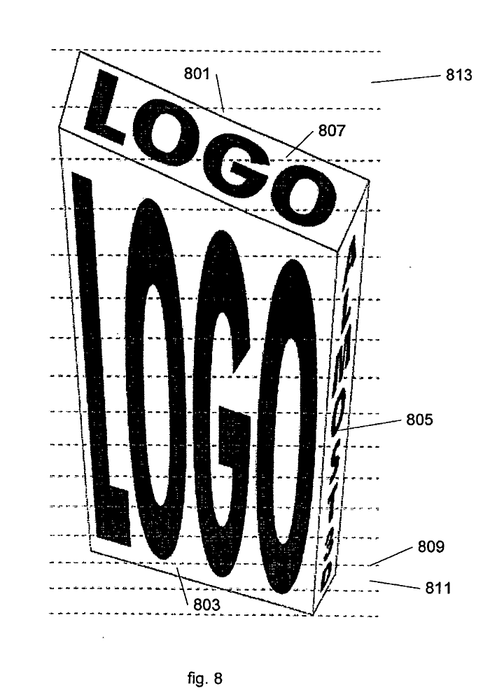

FIG. 7 illustrates an embodiment of a print 701 according to the present invention. The print 701 is a projection of a three-dimensional box with words on the three sides 707, 709 and 711 of the box. The print 701 is made by using linear stretching both in depth and in width by stretching the left part 713 and the right part 715 according to the left and right viewpoint. The distance between the dotted lines 703 illustrates that the length stretching is linear, meaning that each sub mask 705 of the plane of projection has been stretched equally.

FIG. 8 illustrates an embodiment of a print 801 according to the present invention; the print 801 illustrates a three-dimensional box with words on the three sides 803, 805 and 807 of the box. The print 801 is, in this embodiment, made by using proportional stretching both in the width and in depth as described above. The dotted lines 809 illustrates that the lower sub mask 811 of the plane of projection has been stretched less and then the stretch increases to a maximum at the top sub mask 813. As mentioned earlier this is because the angle between the surface and the line from the viewpoint to the sub mask is largest at the lower sub mask and then decreases to a minimum at the top sub mask.

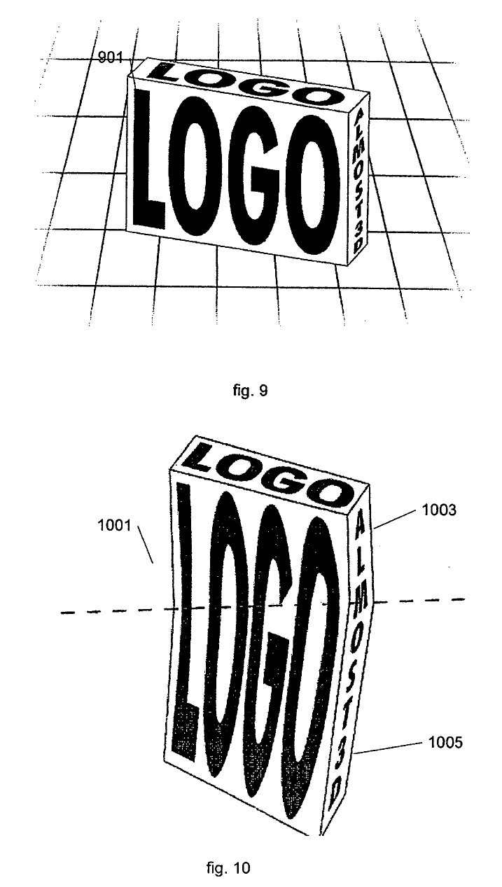

FIG. 9 illustrates how the print of FIG. 7 and 8 is intended to be intercepted as a three-dimensional element 901 by a viewer having two viewpoints. When viewing the print shown in FIG. 7 and 8 from specific viewpoints, the viewer gets the illusion that he/she is looking at a physical three-dimensional box with text on three sides.

FIG. 10 illustrates another embodiment of a print 1001 according to the present invention, where the print is optimised for being placed on a surface having two substantially plane surfaces. The print comprises two parts, one for each plane of the surface, and each print part has been generated according to the described method by performing a projection of a three-dimensional element to each of the two substantially plane surfaces. The print could e.g. be placed where a floor and a wall meet, such that the part 1005 is placed on the floor and the part 1003 is placed on the wall.

FIG. 11 illustrates how the print of FIG. 10 is intended to be intercepted as a three-dimensional element 1101 by a viewer having two viewpoints. When viewing the print shown in FIG. 10 from specific viewpoints, the viewer gets the illusion that he/she is looking at a physical three-dimensional box with text on three sides.

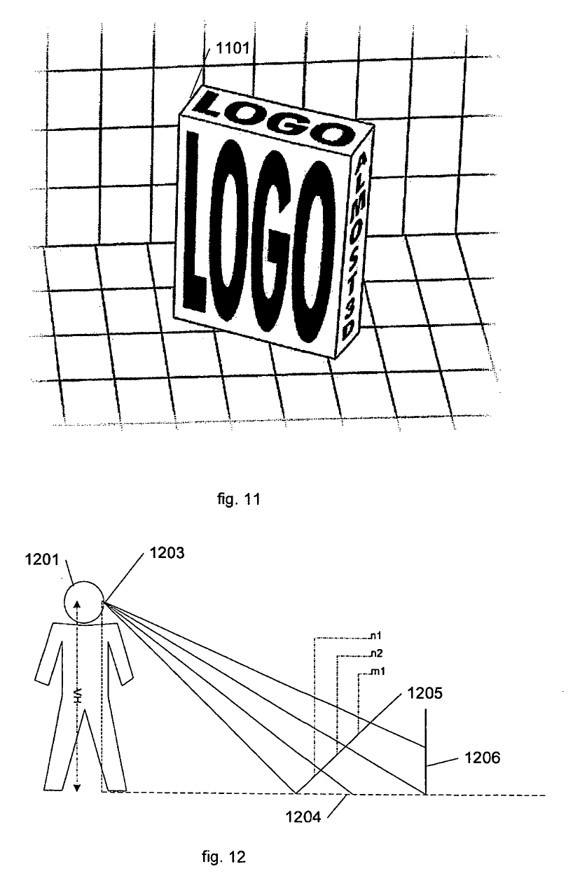

In FIG. 12, it is illustrated how the size of each projected sub mask is determined when projecting a plane of projection to a surface comprising two substantially plane surfaces as illustrated in FIG. 10 and FIG. 11. FIG. 12 illustrates the viewer 1201 with the central fictive viewpoint 1203 and the plane of projection 1205. The plane of projection has been horizontally divided into three sub masks n1, n2 and m1, where n1 and n2 are the sub masks which are to be projected to the first surface 1204, and m1 is the sub mask to be projected to the second surface 1206. In practice the print can now be made by dividing the plane of projection in two parts and then stretching the sub masks in each part according to values calculated in a similar way as described in FIG. 5 for each plane.

It has been described how the projection is first performed according to a central fictive viewpoint, after which the left side is compensated for the right eye and the right side is compensated to the left eye, resulting in a projection where the right side is a perspective projection optimised to the left eye and vice versa. This could also be performed in a similar way such that a projection is obtained where the right side is a perspective projection optimised to the right eye and vice versa. Further, the object to be projected could be fully projected by each eye and then afterwards the two projections could be divided in two parts and combined such that a projection is obtained where the right side is a perspective projection to one eye and the left side is optimised to the other eye. In this case, the projections could be divided in two halves at a centreline and afterwards the left half of one projection is combined with the right half from the other projection, resulting in a single projection.

To further improve the quality of the advertisement print and thereby improve the illusion of a three-dimensional element provided by the advertisement print the advertisement print could after having been generated as described above be further adjusted or tuned until the quality of the illusion is optimized, such further adjustment could include adjusting contrast of the colours, adding or enhancing shadows and enhancing edges in the contents of the print.

One way of performing such adjustments would be by physically generating a new advertisement print each time an adjustment have been made until a satisfactory illusion is obtained. Alternatively, the advertisement print could be simulated on the surface by using a projector connected to a computer containing an electronic version of the designed print. The projector simulates the print on the surface by pointing perpendicular towards the surface, and the creator of the print is able to easily adjust or tune the simulated print until the illusion has been optimised to the creator's satisfaction.

Embodiments have been given of prints for one and two plane surfaces. In principle, prints could be made for all kinds of surfaces by using the method described above and projecting the plane of projection to the surfaces of interest. The print could be made by defining a number of planes on the surface and then calculating, according to the above, how much the sub masks of each part of the plane of projection are to be stretched. In practice the print could e.g. be made by generating a computer model of the surface on which the print is to be placed. The three-dimensional element is then projected to the surface and stretched according to the two viewpoints and afterwards the print is unfolded into a plane surface where after the print (or prints) can be printed and physically placed on the surface on which the illusion is to be provided.

1. An advertisement print being printed on a print carrier, said print illustrates a transformation of a three-dimensional element, where said print is optimised for a viewer simultaneously using two viewpoints, a first viewpoint and a second viewpoint being placed on each side of a central fictive viewpoint, the print comprises:
a right side being a perspective projection of said three-dimensional element to said print carrier, said projection being optimised to said first viewpoint and
a left side being a perspective projection of said three-dimensional element to said print carrier, said projection being optimised to said second viewpoint.

2. An advertisement print according to claim 1, wherein said first viewpoint is placed on the right side of said central fictive viewpoint and wherein said second viewpoint is placed on the left side of said central fictive viewpoint.

3. An advertisement print according to claim 2. wherein said three-dimensional element comprises commercial information.

4. An advertisement print according to claim 1, wherein said print carrier is a removable mat.

5. An advertisement print according to claim 1, wherein said print carrier is a plane surface, such as a ceiling, a floor or a wall.

6. An advertisement print according to claim 1, wherein a projector pointing towards the print carrier provides said print.

7. A method of generating an advertisement print on a print carrier, said print being a transformation of a three-dimensional element, where said transformation is optimised for a viewer simultaneously using two viewpoints, a first viewpoint and a second viewpoint being placed on each side of said central fictive viewpoint, the method comprises the steps of:
performing a perspective projection of the three-dimensional element to said print carrier according to said central fictive viewpoint,
adjusting a right part of said perspective projection according to said first viewpoint,
adjusting a left part of said perspective projection according to said second viewpoint.

8. A method according to claim 7, wherein the step of performing the projection of the three-dimensional element to the print carrier is performed by the steps of:
generating a plane of projection being a two-dimensional image of the three-dimensional element, said plane of projection being generated in a position perpendicular to a line of sight defined between the central fictive viewpoint and the centre of said plane of projection,
perspective projecting the plane of projection to the print carrier according to said central fictive viewpoint.

9. A method according to claim 8, wherein projecting the plane of projection to the print carrier is performed by dividing the plane of projection into a number of horizontal sub masks and then projecting each sub mask to said print carrier according to a line of sight defined between said central viewpoint and a point in said sub mask.

10. A method according to claim 7, wherein the step of adjusting the right part of said perspective projection according to said first line of sight is performed by stretching the right side of the perspective projection towards said first line of sight and wherein the step of adjusting the left part of said perspective projection according to said second line of sight is performed by stretching the left side of the perspective projection towards said second line of sight.

11. A method according to claim 10, wherein the stretching of the right side of the perspective projection towards said first line of sight is performed in such a way that the edges of the right side become parallel with said first line of sight and wherein the stretching of the left side of the perspective projection towards said second line of sight is performed in such a way that the edges of the left side become parallel with said second line of sight.

12. A method according to claim 10, wherein said stretching is performed by dividing the perspective projection into a number of vertical sub masks, stretching each sub mask in the right side of the projection according to a line of sight defined between said sub mask and a first viewpoint, and stretching each sub mask in the left side of the projection according to a line of sight defined between said sub mask and a second viewpoint.

13. A method according to claim 7, wherein said first viewpoint is placed on the right side of said central fictive viewpoint and wherein said second viewpoint is placed on the left side of said central fictive viewpoint.

14. A method according to claim 7, wherein the transformation is further optimised for the viewer by graphically adjusting the contents of the advertisement print.

15. A method according to claim 14, wherein the graphical adjustment is made based on a simulation of the advertisement print on the print carrier.

16. A computer readable medium having stored therein instructions for causing a processing unit to execute the method of claim 7.
